(19) United States
(12) Patent Application Publication
(10) Pub. No.: US 2021/0307318 A1
(43) Pub. Date: Oct. 7, 2021

(54) Process for Preparation of Agrichemical Broadcast Granules

(71) Applicant: GRANULAR PRODUCTS ASSETS PTY LTD, Orange, New South Wales (AU)

(72) Inventor: Graham BARRETT, Orange, New South Wales (AU)

(21) Appl. No.: 17/266,379

(22) PCT Filed: Aug. 20, 2019
(86) PCT No.: PCT/AU2019/050877

§ 371 Date: Feb. 5, 2021

(30) Foreign Application Priority Data
Aug. 21, 2018 (AU) 2018903065

(51) Int. Cl. A01N 25/14; A01N 25/08; A01N 25/30; A01N 47/36; A01N 43/64; A01N 63/23; A01N 37/02

(52) U.S. Cl. CPC A01N 25/14; A01N 25/08; A01N 25/30; A01N 37/02; A01N 43/64; A01N 63/23; A01N 47/36

(57) ABSTRACT

A process for preparation of agrichemical granules comprising: addition of aqueous liquid to a rapidly mixing powder composition comprising a carrier including a hydratable calcium sulfate, to form a pliable moist mixture with rapid mixing wherein the aqueous liquid is added in an amount of at least 5 wt % water by weight of the moist mixture composition; and shaping the pliable moist mixture, preferably comprising extrusion or pelletisation, to form granules.

### FIELD

The invention related to a process for the preparation of agrichemical broadcast granules and in particular preparation of granules containing an agrichemical active and to granules prepared by the process and the control of pests and promotion of plant growth by broadcasting the granules onto land or water for distribution of the active.

### BACKGROUND

Broadcast granules containing agrichemical active agents such as pesticide may be prepared by using an aqueous liquid to produce agglomeration of the finely divided components to form wet granules which are then heated to remove water and harden prior to storage and handling.

Known granulation processes generally involve an operation in which the water and components are blended and processed over an extended period to ensure consistency of the composition and dispersion of the components. This is often conducted in a pan-granulation process in which the particles of the composition are agglomerated by tumbling with continuous application of water over an extended period. Other granulation processes utilise a conical screw mixer to thoroughly mix and knead the components to a dough like consistency which can be formed into granules by casting, tableting or extrusion including roll extrusion. The characteristic powder and/or moist dough residence time in the operation is often 30-60 minutes or more and a final thermal drying process is required to remove the excess water required for the agglomeration of the components. A heat-assisted drying step may be energy-intensive and/or capital-intensive and contributes significantly to granule manufacturing costs. Heat-assisted drying may also degrade active agents located inside the granules, particularly if these active agents are thermally labile.

Pesticides and plant growth promoters are widely used in agriculture in areas of land by both private and commercial operators. Pesticides include herbicides and insecticides and may include sub-lethal doses which promote plant growth. Pesticides compounds may be used alone; however, usually they are formulated as dust, granules, wettable powder, flowable powder, emulsion concentrates, concentrated emulsions, microcapsules, solution concentrates, oils, aerosols, etc., using techniques well known in the art. To improve or stabilize the effects of the pesticide, the pesticide is blended with suitable adjuvants and then used as such or after dilution if necessary. In one embodiment the present invention is directed towards dry broadcast granules, and towards methods of preparing such granules, which can be applied with a dry spreader to a target area by methods such as aerial broadcasting. These granules release their pesticide load when exposed to water, for example, rain, irrigation or by deposition in a body of water.

Broadcast granules may be used to deliver agrichemicals to hard-to-access locations such as remote areas and swamps that contain mosquito-breeding pools by aerial broadcasting from suitably equipped aircraft. Granules for dry broadcast may possess characteristics which are not necessary in compositions designed for admixing in large volumes of water such as tank mixes which are ultimately sprayed upon sites to be treated. Compositions for mixing with water are generally formulated as wettable powders or water dispersible granules, as opposed to the dry broadcast granules. Characteristics which are specific to dry broadcast granules include increased hardness and an ability to maintain integrity upon normal, commercial handling, storage and spreading and yet be capable of quickly delivering the active pesticide content on exposure to water. A problem associated with broadcast granules is the inability of the active pesticide to leave the granule on contact with water such as rain, irrigation water or when deposited in a body of water. Ineffective release of the active agent following contact with water is common problem, for example when the active agent absorbs too deeply into the inert carrier, the active agent is too tightly adhered to the carrier or when the carrier is too hydrophobic to readily allow the ingress of water. It is also desirable for broadcast granules to be relatively uniform in size so as to provide less scattering and drift from the target area of land to be treated.

Australian application 2014256380 (Granular Products) describes a broadcast granule comprising Tebuthiuron herbicide, in which a feature of the process for preparation of the granule involves addition of water to finely divided solid granule components, typically at a level of more than 5% (and up to 15%) by weight of the moist granules. These moist granules are too soft for storage and commercial use, and in order to obtain granules of sufficient hardness, much of the moisture needs to be removed in a heat-assisted drying step.

### SUMMARY OF INVENTION

In accordance with one aspect the invention provides a process for preparation of agrichemical broadcast granules comprising:

addition of aqueous liquid to a rapidly mixing powder composition comprising a carrier including hydratable calcium sulfate to form a pliable moist mixture with rapid mixing wherein the aqueous liquid is added in an amount of at least 5 wt % water by weight of the composition and at least one of the aqueous liquid and powder composition comprise an agrichemical active concentrate; and

shaping the pliable moist mixture to form granules.

The process of shaping may comprise casting, tableting extrusion (which may be roll extrusion) and/or pelletisation. Generally extrusion is preferred and the pliable moist mixture may be extruded to form an extrudate which may be further shaped, for example by cutting, rolling, roll extrusion or a combination of two or more thereof.

The carrier includes a hydratable form of calcium sulfate, particularly calcium sulfate hemihydrate.

One of the significant advantages of the invention is that it provides rapid preparation of hard granules with a relatively high loading of active and without the need for thermal drying. Typically the weight ratio of active agent concentration to hydratable calcium sulfate is at least 1, preferably at least 2, more preferably at least 3, still more preferably at least 5 such as at least 6 or at least 8.

The rapid mixing in the process of the invention allows granules to be prepared which have an excellent crush strength and uniform distribution of components. Typically the water addition and rapidly mixing of the powder composition is carried out for no more than 10 minutes, preferably no more than 5 minutes, more preferably no more than 2 minutes, still more preferably no more than 1 minute and most preferably no more than 30 seconds of commencing water addition.

Rapid mixing of the components may be achieved in a high speed mixer comprising an impeller mounted on a vertical shaft.

The extrusion is typically completed within 20 minutes, preferably 15 minutes, more preferably 10 minutes, of commencing water addition with rapid mixing of the powder composition.

Where shaping involves extrusion the extrudate may be formed into granules by rolling and/or cutting the extrudate, for example in a drum or more preferably in a spheroniser.

The hydratable calcium sulfate is preferably calcium sulfate hemihydrate.

In one embodiment the accelerator and calcium sulfate hemihydrate moiety are present in a weight ratio of between 10:1 to 1:10, preferably in the range 4:1 to 1:4. The accelerator may comprise one or more of sulfates and acid sulfates of alkali metals, and ammonium, cupric, zinc, ferric and aluminium sulfates, and gypsum which may be in fractured or milled form.

### DETAILED DESCRIPTION

Where the terms “comprise”, “comprises”, “comprised” or “comprising” are used in this specification (including the claims) they are to be interpreted as specifying the presence of the stated features, integers, steps or components, but not precluding the presence of one or more other features, integers, steps or components, or group thereof.

The term “hydratable calcium sulphate” refers to a form of calcium sulphate in which the average degree of hydration (on a moles water per mole calcium sulphate basis) is less than 2, preferably less than one, more preferably about 0.5. In a particularly preferred aspect the hydratable calcium sulfate is in the form of the hemihydrate. This material has the formula CaSO₄.(nH₂O), where 0.5 n 0.8 and is commonly referred to as plaster of Paris.

The term “extrudable” is taken to mean that the pliable moist mixture forms a coherent mass when squeezed. In general, the pliable moist mixture is sufficiently mixed so as to not be dusty, because the aqueous liquid added during manufacturing causes agglomeration of finely divided material (and suppression of dust).

The term “extrudate” as used herein refers to the product of extrusion, which in preferred embodiments are cylindrical and which may be produced in cylindrical segments or continuous lengths and subsequently broken into segments by cutting, rolling or and preferably cutting followed by rolling to form rounded granules.

Where used herein the term crush strength refers to the lowest compressive stress that causes the granules to fracture. To determine crush strength granules are placed on a balance and individually crushed firmly with a spatula or other flat surface, by increasing the force applied. The maximum force immediately before breakage was recorded as the crush strength. The median of 15 to 20 measurements was reported and the average determined.

The carrier comprises hydratable calcium sulfate. The hydratable calcium sulfate is preferably present in an amount sufficient to reduce the free water content of the granules and to achieve an average crush strength of at least 150 g and preferably at least 500 g. The crush strength may generally be achieved without the thermal drying conditions previously used and generally the temperature during the process may be within 15° C. of ambient temperature such as within 10° C. of ambient temperature. In one set of embodiments the temperature is in the range of from 5° C. to 40° C. such as from 10° C. to 30° C. The crush strength of the granules of the invention is an advantage which was not expected with use of a relatively low proportion of calcium sulfate hemihydrate. Granules of relatively high crush strength perform more effectively in storage on aerial broadcasting. For example they are less readily deformed on storage are subject to lower fines formation on storage. They also generally exhibit excellent ballistic properties when distributed from aircraft resulting in more accurate distribution and less off-target scattering.

The process comprises addition of aqueous liquid to a rapidly mixing powder composition comprising a carrier composition including the hydratable calcium sulfate. The aqueous liquid may and preferably will be added to the powder in the form of a spray or squirt of the aqueous liquid onto the mixed powder to form the pliable moist mixture with rapid mixing. At least one of the aqueous liquor and the powder will comprise an active agent which may be present as a solution or dispersion in the aqueous liquid or may be present as a solid powder or a liquid or liquid solution or dispersion absorbed onto at least a portion of the carrier component of the powder. In one embodiment the aqueous liquid comprises a fertiliser such as urea, urea/ammonium nitrate mixture, seaweed, liquid seaweed extract or other natural material extract. Generally it is preferred that the powder comprise an active agent which is a agrichemical such as a pesticide which may be in the form of a liquid or low melting point solid absorbed into the carrier, a solution in a suitable liquid carrier absorbed into the carrier powder or a suspension of a particulate active absorbed into the carrier powder. Most preferably the powder comprises a powdered solid pesticidal active. The powder composition is generally free flowing.

The aqueous liquid is preferably sprayed onto the rapidly mixing powder to facilitate even distribution of water during rapid mixing of the powder.

The blending of powders comprising the hydratable calcium sulfate and the addition of water is subject to opposing requirements. If the stirring speed is to slow the time taken to homogenise the powder prior to water addition is increased and water is distributed in an inhomogeneous manner throughout the mixture. This occurs due to the fact that water added first commences the hydration in the contacted material earlier than that added later.

Surprisingly we have found that an over-extended mixing time of the composition can be problematic leading to the formation on inhomogeneous regions in the moist mixture in the form of clumps and balls of mixture which can not easily be disrupted or redispersed.

Accordingly we have found that the use of a short period of rapid mixing can allow the inhomogeneity of too short a mixing time to be avoided and also the formation of balls and clumps caused by an over-extended mixing time to be avoided.

The rapid mixing in the process of the invention allows granules to be prepared which have an excellent crush strength and uniform distribution of components. Typically the water addition and rapidly mixing of the powder composition is carried out for no more than 10 minutes, preferably no more than 5 minutes, more preferably no more than 2 minutes, still more preferably no more than 1 minute and most preferably no more than 30 seconds of commencing water addition.

Water is typically added in the mixture in an amount of at least 5 wt % of the pliable moist mixture, preferably from 8 wt % to 25 wt % such as in the range of from 8 wt % to 20 wt % or 10% to 20% by weight, based on the pliable moist mixture.

The extrusion is typically completed within 20 minutes, preferably within 15 minutes, such as within 10 minutes or within 5 minutes of commencing water addition with rapid mixing of the powder composition.

The High speed mixer may for example comprise a flat-bottomed round vessel with a 2- or 3-blade impeller on a vertical shaft and a lid that is closed in operation. The vessel has a port, typically in the lid, for introducing water, preferably as a spray above and onto the powder while the impellers are rapidly mixing the powder. The high speed mixer will typically also have an outlet chute that can be opened to provide removal the contents of the vessel whilst the impeller is moving.

The granules are preferably prepared from the pliable moist mixture in batches of pliable moist mixture of no more than 200 kg, preferably no more than 100 kg and more preferably no more than 60 kg such as about 40 kg. Using smaller batches preferably no more than 100 kg, more preferably no more than 60 kg allows rapid throughput and an improvement in uniformity of the granule composition.

The use of the high-speed mixer enables blending-in of water to be achieved within a very short period of time such as within two minutes, preferably within 1 minute, more preferably within 30 seconds and most preferably within 10 seconds (compared with 15 mins or more in a low-speed mixer). Mixing of initial relatively dry free flowing powder components may also be finalised within one minute preferably within 30 seconds and more preferably within 10 seconds before commencement of water addition (compared with 15 minutes or more in a low-speed mixer). The optimum time for rapidly mixing the water and dry components to achieve homogeneity of the components can be determined by adding a dye to the water prior to commencement of addition and blending for a time sufficient to achieve a uniform colour.

The homogeneous composition has the appearance of a moist crumb which can be moulded in the hand. Inhomogeneity as a result of an over-extended mixing time is apparent in the formation of balls or clumps formed during mixing.

After water has been added and mixed with the dry components the product is no longer dusty. A suitable test of watered product is the “hand squeeze test” where the desired outcome is a clumping of powder into a coherent mass under hand pressure.

Throughout the process, any product which is unduly dry can generally be restored to a useful consistency by adding water, however product which is too wet may need to be rejected to waste. For this reason, product may be kept somewhat drier than optimal until shaping of the granules by rolling such as in a spheroniser (see below) where final water addition may take place.

Rapid mixing not only enables rapid product throughput (for example 40 kg per blend with a rapid mixing time of 20 seconds following the commencement of water addition, but also enables the particles to be exposed to a uniform environment such as a more uniform water contact and timing of water contact. In other words the particles experience the same “water contact history”. This is quite different from conventional low-speed mixers where there is a relatively broad variation in the timing and extent of water-contact throughout the blend.

The reaction of water and hydratable calcium sulfate leads to the formation of interlocking gypsum crystals and crystal development may involve nucleation events and produce significant variability and is exothermic. This has the potential to produce a significant variation in properties throughout the granule and may result in less effective distribution of the active on contact with water and a greater proportion of fines being generated from more brittle surface portion of the granules. We have found that the rapid mixing process of the invention allows a more consistent water consistency and history to be experience by the particles of the pliable moist mixture. This tends to significantly improve final product uniformity and quality. The process control parameters which are provided by the invention include (i) avoiding overmixing moist product, (ii) adding the correct amount of water; (iii) providing sufficiently rapid agitation; and (iv) avoiding under-mixing. Over-mixing leads to heating of the product and poor cohesion after extrusion.

After the moisture-addition step in the high-speed mixer, the moist product may leave the mixing vessel via the discharge chute (while the impeller may still be in rapid motion) and fall by gravity into a hopper that has a horizontal screw located at the base.

The pliable moist mixture may be transferred into an extruder such as into the basket of a basket extruder. A preferred extruder is a basket extruder having a round basket (such as a 30 cm basket that rotates around a vertical axis). The transfer may be achieved using a screw feed. An impeller inside the basket forces moist material through the holes such as 1 mm to 5 mm holes (preferably about 3 mm-4 mm) in the basket, and one or more fixed blades on the outside of the basket cut the extruded strands. Chopped strands are collected in a bucket and the extrusion time for a 40 kg batch is about 10 minutes.

Chopped strands (40 kg) are placed inside the spheroniser, and the spinning plate of the spheroniser is turned on for about 10 minutes (per 40 kg batch). During spheronisation a water stream (about 300 mls per 40 kg batch) is slowly fed into the interior of the spheroniser.

After leaving the spheroniser the granules pass through an inclined-plane fluid bed drier (driven by ambient temperature air bursts) and from there to a sieve where oversize clumps are removed.

The rapid mixing of the powder is typically carried out in a high speed mixer comprising an impeller mounted on a vertical shaft. The impeller may be a multiblade impeller, for example including two or three blades. The tip speed of the impeller may for example be at least 5 m/s, preferably at least 10 m/s such as 10 m/s to 30 m/s. The rotational velocity of the impeller may be at least 100 r.p.m., preferably at least 300 r.p.m. such as in the range of 300 r.p.m. to 600 r.p.m.

The rapid mixing results in the formation of a pliable moist mixture which is extrudable to form a pliable moist mixture which can be shaped by extrusion in a low or high pressure process. The water addition and rapid mixing of the powder composition is carried out for no more than 10 minutes, preferably no more than 5 minutes, more preferably no more than 2 minutes, still more preferably no more than 1 minute and most preferably no more than 30 seconds of commencing water addition to form the pliable moist mixture for formation of granules such as by extrusion.

The process may comprise extruding the pliable moist mixture to form an extrudate. The extrudate will generally be of diameter of about 1 mm to about 4 mm and be formed using a low pressure extruder such as a basket extruder having extrusion orifices of diameter about 1 mm to about 4 mm.

The extrusion is preferably completed within 20 minutes, more preferably within 10 minutes such as within 8 or 5 minutes of commencing water addition.

Shaping the extrudate to form granules may be achieved using a mould or roll extruder but is preferably carried out by cutting and/or rolling the extrudate and preferably cutting and rolling. The rolling process may be carried out in a drum or other suitable rolling device and it is particularly preferred to shape the granules by rolling the granules using a spheroniser.

The process is preferably carried out in an environment where delta-T is at least 1° C., preferably at least 2° C., The delta-Tis preferably no more than 10° C., more preferably no more than 8° C. Accordingly the delta-T in some embodiments is 1° C. to 10° C., such as 2° C. to 10° C., 1° C. to 8° C. or 2° C. to 10° C.

Delta-T is the difference between the dry-bulb temperature and the wet-bulb temperature in the environs of the equipment used for the process including mixing of the components with water and formation of granules, preferably by extrusion of a moist paste. The following Table 1 shows the inter-relationship between the delta T, dry bulb temperature and wet bulb temperature.

TABLE 1

| Dry | Number of degrees difference between the | | | | | | | | | |
|---|---|---|---|---|---|---|---|---|---|---|
| Bulb | wet-and dry-bulb readings (° C.) | | | | | | | | | |
| (° C.) | 1 | 2 | 3 | 4 | 5 | 6 | 7 | 8 | 9 | 10 |
| 10 | 88% | 77 | 66 | 56 | 45 | 35 | 26 | 16 | 7 | — |
| 11 | 89 | 78 | 67 | 57 | 47 | 38 | 28 | 19 | 11 | 2 |
| 12 | 89 | 79 | 68 | 59 | 49 | 40 | 31 | 22 | 14 | 5 |
| 13 | 89 | 79 | 69 | 60 | 51 | 42 | 33 | 25 | 16 | 9 |
| 14 | 90 | 80 | 70 | 61 | 52 | 43 | 35 | 27 | 19 | 11 |
| 15 | 90 | 80 | 71 | 62 | 54 | 45 | 37 | 29 | 22 | 14 |
| 16 | 90 | 81 | 72 | 63 | 55 | 47 | 39 | 31 | 24 | 17 |
| 17 | 91 | 82 | 73 | 64 | 56 | 48 | 41 | 33 | 26 | 19 |
| 18 | 91 | 82 | 73 | 65 | 57 | 50 | 42 | 35 | 28 | 21 |
| 19 | 91 | 82 | 74 | 66 | 58 | 51 | 44 | 37 | 30 | 24 |
| 20 | 91 | 83 | 75 | 67 | 59 | 52 | 45 | 38 | 32 | 26 |
| 21 | 91 | 83 | 75 | 68 | 60 | 53 | 47 | 40 | 34 | 27 |
| 22 | 92 | 84 | 76 | 69 | 61 | 54 | 48 | 41 | 35 | 29 |
| 23 | 92 | 84 | 77 | 69 | 62 | 56 | 49 | 43 | 37 | 31 |
| 24 | 92 | 84 | 77 | 70 | 63 | 57 | 50 | 44 | 38 | 32 |
| 25 | 92 | 85 | 77 | 71 | 64 | 57 | 51 | 45 | 40 | 34 |
| 26 | 92 | 85 | 78 | 71 | 65 | 58 | 52 | 46 | 41 | 35 |
| 27 | 93 | 85 | 78 | 72 | 65 | 59 | 53 | 47 | 42 | 37 |
| 28 | 93 | 86 | 79 | 72 | 66 | 60 | 54 | 49 | 43 | 38 |
| 29 | 93 | 86 | 79 | 73 | 67 | 61 | 55 | 50 | 44 | 39 |
| 30 | 93 | 86 | 80 | 73 | 67 | 61 | 56 | 50 | 45 | 40 |
| 31 | 93 | 86 | 80 | 74 | 68 | 62 | 57 | 51 | 46 | 41 |
| 32 | 93 | 87 | 80 | 74 | 68 | 63 | 57 | 52 | 47 | 42 |
| 33 | 93 | 87 | 81 | 75 | 69 | 63 | 58 | 53 | 48 | 43 |
| 34 | 93 | 87 | 81 | 75 | 69 | 64 | 59 | 54 | 49 | 44 |

Without wishing to be bound by theory, it is believed that when delta-T is less than about 2° C., the ambient humidity is sufficiently high to compromise the activity of the hydratable calcium sulfate, particularly in the domain close to the surface of the moist mixture, or the surface of the granules during granule formation. When delta-T is greater than about 8° C., the ambient air is sufficiently dry to cause moisture loss at the surface of the pliable moist mixture, or at the surface of the granules.

It is considered likely that a moisture inhomogeneity at the surface of moist mixture and/or granules leads to less desirable granule morphology in terms of reduced uniformity within or between granules. The issue of moisture inhomogeneity is more important in granule formation processes where the granule ingredients compromise modest amounts of hydratable calcium sulfate (e.g. less than 40% by weight of dry blend powder and greater than 2% by weight).

In one preference the blending of the aqueous liquor and the dry powder blend takes place in the same vessel as the vessel wherein dry powder blending took place.

The hydratable calcium sulfate may be used in relatively low amounts so as to provide an opportunity to include relatively high loadings of one or more active agents. In preferred embodiments the ratio of dry weight of the granule components to hydratable calcium sulfate (such as calcium sulfate hemihydrate) is at least 3:1, more preferably at 4:1 such as at least 6:1 or at least 8:1.

The agrichemical active comprises at least one selected from the group consisting of pesticides plant promoters, and fertiliser. The active will typically include an active selected from the group consisting of herbicides, insecticides, fungicides, molluscicides, plant growth regulators, nematicides, rodenticides and algicides, plant hormones, plant nutrients, trace elements, bioactive proteins, soil wetters, soil conditioning materials, humic substances and fulvic substances.

In one set of embodiments the active agrichemical comprises one or more pesticides selected from the group consisting of tebuthiuron, Bacillus thuringiensis, hexazinone and flupropanate.

In preferred embodiments the process includes at least one pesticide selected from the group consisting of tebuthiuron, hexazinone present in an amount of from 20% to 85% (preferably from 30% to 75%, most preferably from 40% to 60%) by weight based on the dry weight of the granule components. In another embodiment the active agent is flupropanate present in an amount of 5 wt % to 60 wt %, preferably 10 wt % to 40 wt % and more preferably 15 wt % to 30 wt % based on the dry weight if the composition.

The granular composition may comprise a surfactant. The surfactant may be a solid or liquid and may be added to the powder component of the composition or added with the aqueous liquid to the powder components.

The powder may comprise an accelerator or retarder for the hydratable calcium sulfate particularly in the case of calcium sulfate hemihydrate.

The carrier may include hydratable calcium sulfate and an accelerating agent for hydration of the hydratable calcium sulfate selected from the group consisting of non-hydratable calcium sulfate such as calcium sulfate dihydrate, non-hydratable non-calcium sulfate salts such as salts based on fully hydrated zinc sulfate and aluminium sulfate. It is preferred that the accelerating agent is of particle size of 30 microns to 150 microns.

In one embodiment the accelerator comprises BMA (ball milled accelerator), which may comprise ball milled gypsum such as gypsum ball milled with a material selected from starch, sugar or surfactant. The milling in the presence of these materials allows the activity of the accelerator to be maintained minimising the loss of activity with storage.

In one preference the volume of the dry-blending vessel is no more than 500 litres such as no more than 300 and no more than 200 litres.

The powder components comprising the carrier including the hydratable calcium sulfate preferably also include the agrichemical active such as one or more pesticides may be prepared prior to aqueous liquid addition by dry-blending of the components in a vessel equipped with a high tip-speed impeller blade such as used in rapid mixing of the powder with water, and the tip speed of the blade is at least 5 m/s, preferably at least 10 m/s such as 10 m/s to 30 m/s. The rotational velocity of the impeller may be at least 100 r.p.m., preferably at least 300 r.p.m. such as in the range of 300 r.p.m. to 600 r.p.m.

The powders may be added to the mixing vessel while the impeller blade is at rest, and after the addition, the blending is achieved by causing the impeller to rotate at high tip speed. In one embodiment the duration of the blend process to form the dry powder blend is less than 2 minutes.

In one aspect the process produces hard granules comprising at least one agrichemical active and comprises:

(1) a first step of blending finely divided ingredients (powders), wherein at least one of the powder ingredients is an hydratable calcium sulfate, and wherein optionally one of the powder ingredients is an accelerator for the hydratable calcium sulfate, and wherein the ratio of active agent or active agent concentrate to hydratable calcium sulfate is at least 1, preferably at least 2, more preferably at least 3, such as at least 6 and the ratio to hydratable calcium sulfate to accelerator, such as gypsum, is 1:10 to 10:1 such as 1:4 to 4:1;

(2) a second step of rapid addition and rapid blending of the aqueous liquid to the powder blend of the first step to form an extrudable moist mixture;

(3) a third step of extruding the extrudable moist mixture to form an extrudate preferably in segments; and

(4) optionally a fourth step of rolling the extrudate to form granules.

In one embodiment the aqueous liquid that leads to the formation of extrudable moist mixture is added to the same vessel as used in blending the powder and the addition of the time taken for addition of the aqueous liquid that promotes powder agglomeration and formation of the extrudable moist mixture is no more than 5 minutes, preferably no more than 2 minutes, more preferably no more than 1 minute, still more preferably no more than 0.5 minutes, such as about 10 seconds. Generally the time will be at least about 5 seconds.

In one preference, the extrudable moist mixture is delivered from the high speed mixer vessel to the extruder or other shaping device. This may be done by delivering the extrudable moist mixture into a hopper with a screw feed that conveys crumb to the feed hopper of a high-pressure or low-pressure extruder.

In one embodiment the squeezing of moist mixture (and attendant formation of extrudate takes place in a low-pressure or high-pressure extruder, or a roll extruder. A low pressure basket extruder is preferred and the residence time of extrudable moist mixture in forming the extrudate is less than 20 minutes, preferably less than 10 minutes, more preferably less than 5 minutes.

In one preference the time elapsed between the start of step 2 and the conclusion of step 3 is less than 20 minutes, preferably less than 10 mins more preferably less than 5 mins.

In one embodiment the shaping comprises one or more operations chosen from the set consisting of spheronisation, sieving, fluid bed ambient-temperature agitation.

In one preference the manufacturing temperature is in the range 5° C.-50° C., preferably 15° C.-25° C., more preferably 10° C.-25° C.

The extrudable moist mixture may be extruded and then subject to a tumbling action in a rotatable mixer such as a drum mixer, which may be cylindrical or narrowing taper to an opening and which may comprise baffles on the inner wall to promote rounding of the broken extrudate. In one aspect the tumbling or rolling period may be between 30 seconds to 5 minutes. In the embodiment a rotatable drum is used.

Most preferably the granules are prepared from the extrudable moist mixture by extrusion followed by spheronisation. The technique generally involves extrusion of the moist mixture, breaking up the extrudate into segments and rounding the segments of extrudate into spheres (spheronisation). Hosokawa BEPEX GmbH (http://www.hosokawamicron.com) describes one example of the technique of low-pressure extrusion and spheronisation for the production of rounded granules.

In one embodiment a fine water or aqueous spray is applied to the granules in the spheroniser. Application of a fine spray can reduce dust formation and provide high yields of spherical granules. The spheroniser may be in the form of a rapidly rotating disc or dimpled disc. In one embodiment water or aqueous liquid is applied as a spray onto the granules during the spheronisation process. The amount of water or aqueous liquid applied to the granules during spheronisation may, for example, be in the range of from 0.3% to 3% of the starting weight of granules in the spheroniser.

In one embodiment the components in the first processing stage (dry powder blending) include components chosen from the group consisting of active ingredient (including tebuthiuron), hydratable calcium sulphate, accelerator additive as defined, dispersing agent, wetting agent, lubricating agent, additional carrier and binding agent. An aqueous liquor is combined with the components in a subsequent step or steps, e.g. during the second, third or optional fourth step.

In one set of embodiments the pliable moist mix is granulated by extruding the moist mix using a low pressure basket extruder comprising a basket rotating on a vertical axis with orifices for the extrusion of extrudate. The extrusion orifices are preferably from about 1 mm in diameter to about 4 mm, preferably 1.5 mm to 3 mm in diameter, more preferably from about 2 mm in diameter to about 3 mm in diameter.

In one set of embodiments the cylindrical basket is rotated about the vertical axis and a counter rotating stirrer inside the cylinder forces moist crumb through the basket orifices. We have found that the preparation of granules of the desired morphology is enhanced when the basket extruder is provided with one or more external cutting blades may be placed adjacent the outer surface of the rotating basket and the number of said external cutting blades is preferably 2 or more, more preferably 4 or more, even more preferably 6 or more. After cutting, the extrudate may be spheronised to provide shaped granules.

The granules preferably have an average aspect ratio in the range 1 to 1.5. The aspect ratio is the ratio of the largest dimension of a granule divided by the smallest dimension. In one embodiment the granules have an average aspect ratio of from 1 to 1.3 such as from 1 to 1.2. In a further embodiment, the standard deviation of the distribution of individual particle aspect ratios throughout the sample is less than 0.4, preferably less than 0.3, more preferably less than 0.2 and most preferably less than 0.15.

In a preferred embodiment the granules of the composition preferably have a size wherein at least 70% w/w, preferably at least 80% w/w (more preferably at least 90% w/w and still more preferably at least 95% w/w) of the granules have an aspect ratio in the range of from 1 to 1.5 preferable from 1 to 1.2 and the weight average particle diameter in the range of from 1 mm to 4 mm (preferably 1.5 to 3.5 mm). This is particularly important for aerial broadcasting of the granules from an aircraft where it is important to obtain uniform coverage of the land to be treated with minimal packing volume of the composition.

The average crush strength (hardness) of the granules is preferably at least 150 g, more preferably at least 200 g, still more preferably at least 300 g such as at least 400 g or at least 500 g. In prior processes, granule hardness is lower when more water is retained within the granule, and granule hardness is greater when more water is removed by drying by thermal drying. The present invention, by contrast allows hardness to be provided (as determined by high crush strength) to be developed as a result of the action of the hydratable calcium sulfate without a requirement for thermal drying.

Hardness testing is a suitable method to monitor crush strength, e.g. applying pressure to individual granules on a weighing scale and noting maximum scale reading before granule disintegration.

In one set of embodiments the individual granules have an average density of greater than 1 g/ml, preferably greater than 1.05 g/ml.

The agrichemical active agent is preferably reasonably soluble or dispersable in water, such that contact of the granule with rain, irrigation or a body of water such as a shallow pond will lead to rapid egress of substantial quantities of specialty or bioactive agent from the inside to the outside of the granule.

In one embodiment the active agent is a liquid, liquid concentrate or low melting point solid, that has been sorbed into a finely divided porous carrier such a porous silica or diatomaceous earth. The liquid concentrate may be a concentrated solution of flupronante salt, such as flupropanate sodium.

In one embodiment the active agent comprises an insecticidal protein or spore or both protein and spore from the species Bacillus, such as Bacillus thuringiensis or Bacillus sphaericus.

In one embodiment the hydratable calcium sulfate is used with an accelerating agent that promotes the hydration of the hydratable calcium sulfate.

In one preference the hydratable calcium sulfate comprises calcium sulphate hemihydrate.

In one preference the hydratable calcium sulfate is calcium sulfate hemihydrate and an accelerator is present that promotes the hydration of the calcium sulfate hemihydrate.

The accelerator that promotes the hydration of calcium sulfate hemihydrate is preferably selected from the group consisting of sulfates and acid sulfates of alkali metals, and ammonium, cupric, zinc, ferric and aluminium sulfates, and gypsum which may be in a fractured or milled form.

In one embodiment the accelerator and calcium sulfate hemihydrate moiety are present in a weight ratio of between 10:1 to 1:10, preferably in the range 4:1 to 1:4. Surprisingly it was found that the use of such a high proportion of accelerator advantageously allows development of good crush strength with a low amount of hydratable calcium capacity this allows a higher load of active concentrate to be used than has generally been possible for granules formed with a hardening component such as a cementitious material. Indeed the amount of accelerating agent often used with calcium sulfate hemihydrate in forming hardened composite materials is typically 100 parts calcium sulfate hemihydrate to 1 part or less of gypsum.

In one embodiment the accelerator comprises ball-milled gypsum (calcium sulfate dihydrate) and the incompletely hydratable calcium sulfate is calcium sulfate hemihydrate, and the ratio of gypsum to calcium sulfate hemihydrate is in the range 4:1 to 1:10, preferably in the range 4:1 to 1:4, more preferably 2:1 to 1:4, such as 1.5:1 to 1:2.

The granules preferably comprise a surface-active agent that can have one or more of the following functions: (i) facilitate wetting of the powder components during granule formation, (ii) facilitates wetting of the granule after application by water such as ambient water or rain, and (iii) facilitates re-shaping such as takes place inside a spheroniser. The surface active agent may comprise sulfonated agents such as lignosulfonate or naphthalene sulfonate or naphthalene sulfonate formaldehyde condensate agents.

As used herein, the term surfactant refers to agents capable of facilitating spread of water over the surface of the granule components and admitting water to the granule interior and facilitating reshaping of the granule. The surfactant component will generally accelerate delivery of the active from the granule in the presence of water. Surfactants may act as detergents, wetting agents, emulsifiers, foaming agents and/or disintegrants.

Generally speaking the surfactant component assists in performance of the granule once broadcast onto land to be treated with pesticide by accelerating wetting and delivery of the pesticide from the granules in the presence of water from rain or irrigation. Surfactants may also assist in delivering the pesticide across a greater area of land than would otherwise occur by facilitating leaching of the pesticide and disintegration of the granule.

Suitable surfactant may be chosen without undue experimentation having regard to the appearance to the granules following spheronisation. We have found the less effective surfactants result in the granules having a speckled appearance possible due to fewer nucleation sites for crystal hydrate formation.

Surfactants are usually amphiphilic organic compounds. The granular composition preferably comprises a surfactant which aids in providing rapid distribution of the pesticidal active in the presence of water such as from rain or irrigation. The surfactant may be an anionic, cationic, non-ionic, amphoteric surfactant or mixture of two or more thereof. Examples of non-ionic surfactants include alcohol ethoxylates such as C₁₀ to C₁₈ alkyl alcohols ethoxylated with from 2 to 8 ethylene oxide units, such as C₁₄ to C₁₆ alkanols ethoxylated with 5EO units, nonyl phenol ethoxylates such as nonyl phenol with 4 to 8 EO units, tallow amine ethoxylates such as tallow amine with 8 to 12 EO units and EO-PO-EO block copolymers such as block copolymers of molecular weight 1000 to 5000. Other examples include sodium salt of acid resin copolymer (e.g. Tersperse 2700), sodium-N-methyl-N-oleyl taurate (e.g. Geropon T77), sodium polycarboxylate (e.g. Geropon T36) and modified styrene acrylic polymer (e.g. Atlox Metasperse 550S).

The preferred surfactant comprise anionic surfactants. Examples of anionic surfactants include sulfonate surfactants. Examples of anionic surfactants including substituted and polymeric alkyl and aryl sulfonates such as sodium alkyl naphthalene sulfonate, sodium napthalene sulfonate, calcium lignosulfonate, sodium lignosulfonate, and ammonium lignosulfonate. A preferred example is sodium lignosulfonate such as available under the trade name “Reax 85A” or “Lignin DS10” (“Redox”).

The carrier component may, in addition to hydratable calcium sulphate, further comprise one or more additional components. The additional carrier can be any of the carriers known in the art of granule formation. Preferred additional carrier components are selected from a range on inorganic materials such as clays, talc, sodium sulphate, pyrophillite clay, attapulgite clay, kaolin clay, kieselguhr, chalk, diatomaceous earth, lime, calcium carbonate, bentonite clay, Fuller's earth and the like or organics such as urea. The carrier may be chosen from the set consisting of clay, talc, sodium sulphate, silica, attapulgite, kaolin, chalk, limestone, diatomaceous earth, bentonite and urea.

The preferred additional carrier component preferably comprises clay and more preferably kaolinite and present in an amount of up to 80% by weight, preferably from 5% to 75%, more preferably 10% to 50% such as 20% to 40% such as about 30% by weight of the dry weight of the composition. In one set of embodiments the granules comprise a powdered clay carrier in an amount in the range of from 10% to 60% by weight based on the dry weight of the components. In one embodiment the carrier comprises a relatively minor proportion of silica such as up to 15% (preferably 5% to 10%) by weight of the granule composition.

Urea may be used as a granule component and may bind other components in the presence of moisture.

Examples of the pesticide component of the broadcast granules may be selected from the group consisting of herbicides, insecticides, fungicides, molluscicides, plant growth regulators, nematicides, rodenticides and algicides.

Preferred pesticides include herbicides and insecticides.

Specific examples of preferred of the agrichemical active agent may comprise one or more selected from the group consisting of Acetochlor, Allidochlor, Diallate, Metolachlor, Prosulfocarb, Triallate, Trifluralin, Metribuzin, Diuron, bentazone, hexazinone, tebuthiuron, sulfentrazone, imazapic, imazapyr, MSMA, Ametryn, clomazone, isoxaflutole, mesotrione, amicarbazone, atrazine, all forms of 2,4-D, especially salts which are active through root absorption, Pendimethalin, Saflufenacil, Flupropanate, Trifludimoxazin, Bacillus thuringiensis, Bendiocarb, chlorpyrifos, Chlorfenapyr, Fipronil, Imidacloprid and Metaldehyde.

Examples of low-melting point (less than 40° C.) soil-applied herbicides which may be used in the process of the invention include: Acetachlor, Allidochlor, clomazone, diallate, triallate, metolachlor and prosulfocarb.

According to a preferred embodiment, the pesticide comprises at least one herbicide selected from metribuzin, diuron, bentazone, hexazinone, tebuthiuron, sulfentrazone, imazapic, imazapyr, glyphosate, MSMA, ametryn, clomazone, isoxaflutole, mesotrione, amicarbazone, atrazine, paraquat, 2,4-D, pendimethalin, saflufenacil, flupropanate and trifludimoxazin.

Examples of herbicides may be selected from the group consisting of:

(i) imidazolinones such as selected from imazamox, imazapic, imazapyr, imazaquin and imazethapyr;

(ii) PPO inhibitors such as selected from saflufenacil, sulfentrazone, flumioxazin, fomesafen, oxadiazon, oxyfluorfen, carfentrazone-ethyl and 1,5-dimethyl-6-thioxo-3-(2,2,7-trifluoro-3-oxo-4-(prop-2-ynyl)-3,4-dihydr-o-2H-benzo[b][1,4]oxazin-6-yl)-1,3,5-triazinane-2,4-dione (CAS 1258836-72-4);

(iii) bleacher herbicides such as selected from isoxaflutole, topramezone, mesotrione, fenquintrione, bicyclopyrone and clomazone;

(iv) photosynthesis inhibitors such as selected from atrazine, ametryn, terbutryn, simazine, terbutylazine, bentazone, hexazinone, amicarbazone, metribuzin, bromacil, ioxynil, tebuthiuron, diuron, linuron, isouron, diquat and paraquat;

(v) auxin herbicides such as selected from 2,4-D, 2,4-DB, MCPA, picloram, dicamba, triclopyr, fluroxypyr, halauxifen and aminopyralid;

(vi) VLCFA inhibitors such as selected from metolachlor, (S)-metolachlor, dimethenamide, dimethenamide-P, acetochlor, alachlor and pyroxasulfone;

(vii) sulfonylurea herbicides such as selected from ethoxysulfuron, trifloxysulfuron, sulfometuron, metsulfuron, halosulfuron, iodosulfuron and chlorimuron;

(viii) ACCase inhibitors such as selected from clethodim, cycloxydim, sethoxydim, profoxydim, tepraloxydim, fluazifop, fluazifop-P, haloxyfop and haloxyfop-P;

(ix) Chlorocarbonic acids such as 2,2-DPA and flupropanate;

(x) other herbicides such as glyphosate, glufosinate, pendimethalin, trifluralin, diclosulam, asulam, MSMA, TCA and indaziflam, triflidimoxazin and the agronomically suitable salts, amides and esters of the herbicides.

Examples of insecticides may be selected from Acephate, Acetamiprid, Abamectin, Bacillus thuringiensis, Bendiocarb, Benfuracarb, Beta Cyfluthrin, Bifenazate, Buprofezin, Captan, Carbaryl, Carbofuran, Carbosulfan, Cartap Hydrochloride, Chlorfenapyr, Deltamethrin, Diazinon, Emamectin benzoate, Fenpyroximate, Fipronil, Flubendiamide, Flufenzine, Hexythiazox, Imidacloprid, Lindane, Metaldehyde, Prallethrin, Thiacloprid, Thiamethoxam, and Thiodicarb.

Examples of Preferred insecticides which may be used in the pesticide component of the broadcast granules includes microbial insecticides such as Bacillus thuringiensis (such as Bacillus thuringiensis israelensis), and Bacillus sphericus effective for the control of immature flies such as mosquitoes (Culicidae), aquatic midges (Chironomidae), mushroom flies (Sciaridae). The insecticide Bt (Bacillus thuringiensis) is an example of a preferred insecticide.

The preferred pesticide active has at least some degree of water solubility or water dispersible so as to allow the active to be delivered from the granule when the granule has been deposited at the site of use and contacts water, for example from rain, irrigation or being deposited in a body of water.

In one embodiment the pesticides are chosen from the set consisting of Tebuthiuron, Bacillus thuringiensis, hexazinone, flupropanate.

Examples of insecticides may be selected from Acephate, Acetamiprid, Abamectin, Bacillus thuringiensis, Bendiocarb, Benfuracarb, Beta Cyfluthrin, Bifenazate, Buprofezin, Captan, Carbaryl, Carbofuran, Carbosulfan, Cartap Hydrochloride, Chlorfenapyr, Deltamethrin, Diazinon, Emamectin benzoate, Fenpyroximate, Fipronil, Flubendiamide, Flufenzine, Hexythiazox, Imidacloprid, Lindane, Metaldehyde, Prallethrin, Thiacloprid, Thiamethoxam, and Thiodicarb. Preferred insecticides which may be used in the pesticide component of the broadcast granules includes microbial insecticides such as Bacillus thuringiensis (such as Bacillus thuringiensis israelensis), and Bacillus sphericus effective for the control of immature flies such as mosquitoes (Culicidae), aquatic midges (Chironomidae), mushroom flies (Sciaridae). The insecticide Bt (Bacillus thuringiensis) is an example of a preferred insecticide. Bt is thermally labile and the process of the invention allows high activity of Bt to be preserved in the broadcast granules of the invention by allowing granule formation under mild conditions.

In preferred embodiments the moist mixture comprises a pesticide active concentrate in an amount in the range of from 20% to 85% (preferably from 30% to 75%, most preferably from 40% to 60%) by weight based on the dry weight of the components of the composition.

The term pesticide active concentrate may be the most concentrated form of the active agent that is conveniently available to the manufacturer. These concentrates can be highly concentrated such as at least 95% w/w pesticide in the case of organic chemicals or less concentrated such as at least 10% w/w active pesticide in the case of microbial pesticides such as Bt concentrate, which is harvested from a fermentation broth and may be 20% w/w concentrated or even less). In the preferred embodiment the pesticide active is present in an amount of 20% to 85% (preferably from 30% to 75%, most preferably from 40% to 60%) by weight based on the dry weight of the components of the composition. In a more specific preferred embodiments the moist mixture preferably comprises a pesticide selected from tebuthiuron, hexazinone and flupropanate, more preferably tebuthiuron, in an amount in the range of from 20% to 85% (preferably from 30% to 75%, most preferably from 40% to 60%) by weight based on the weight of the total of active and powdered carrier components.

The ratio of active concentrate to hydratable calcium sulfate (preferably the ratio of active per se to calcium sulfate) is typically at least 2:1, preferably at least 3:1, still more preferably at least 4:1 such as at least 6:1 or at least 8:1.

In one embodiment, the finely divided (powder) blend comprises about 15%-75% by weight of agrichemical active agent, or of the concentrate that contains the specialty agrichemical active agent. In a scenario where the bioactive agent cannot be provided as a near-100% material (eg where the bioactive agent is made in a fermentation vessel), the weight limits 15%-75% refer to the weight of the concentrate used (rather than the weight of the refined bioactive agent). By way of further example, a liquid bioactive agent can be sorbed into finely divided porous silica—in this case the bioactive formulation concentrate comprises silica and sorbed liquid.

In one embodiment, the finely divided (powder) blend comprises 2-40% of hydratable calcium sulfate, preferably 2-25%, more preferably 3-10% of hydratable calcium sulfate.

The finely divided (powder) blend preferably comprises 2-30% of accelerator for the hydratable calcium sulfate, preferably 3% to 20% more preferably 4% to 15%.

As used herein, the term surface active agent or surfactant refers to agents capable of facilitating spread of water over the surface of the granule components and admitting water to the granule interior. The surfactant component will generally accelerate delivery of the active from the granule in the presence of water. Surfactants may act as detergents, wetting agents, emulsifiers, foaming agents and/or disintegrants.

Generally speaking the surfactant component assists in performance of the granule once broadcast onto land to be treated with pesticide by accelerating wetting and delivery of the active agent from the granules in the presence of water from rain or irrigation. Surfactants may also assist in delivering the pesticide across a greater area of land than would otherwise occur by facilitating leaching of the pesticide and disintegration of the granule.

Urea may be used as granule carrier component and may assist in binding other components in the presence of moisture.

In preferred embodiments the moist mixture preferably comprises specialty chemical or bioactive agent in an amount in the range of from 20% to 85% (preferably from 30% to 75%, most preferably from 40% to 60%) by weight based on the weight of the total of active and powdered carrier components.

In one example the rapid mixing comprises the addition of the aqueous liquid to the rapidly mixing powder composition comprising tebuthiuron active agent, calcium sulfate hemihydrate, gypsum accelerator, sulfate surfactant and carrier (preferably a clay carrier. The weight of components based on the weight of pliable most mixture may comprise:

8% to 20% water;

40% to 60% tebuthiuron or hexazinone;

3% to 6% calcium sulfate hemihydrate;

3% to 6% gypsum;

10% to 35% carrier such as clay; and

0% to 15% sulfate surfactant.

In a further set of embodiments there is provided a method of controlling weeds in an area of land comprising applying to the area of land by aerial broadcasting of the granular composition as herein described. The granular composition is typically distributed in dry form from an aircraft such as a fixed wing aeroplane or helicopter.

The method is useful in weed control on land infested with one or more target weeds selected from the group consisting of brigalow, parkinsonia, prickly acacia, mimosa pigra, black tea tree, broadleaf tea tree, cocky apple, paperbark teatree, poplar gum, swamp box, African boxthorn, coolibah, rubbervine, whitewood, belah, currant bush, lime bush, dawson gum, false sandalwood, hollybush, poplar box, yellow wood, silver leaved ironbark, brown box, gidgee, gum-topped box, groundsel bush, lantana, wild rosemary, gorse and parthenium. In a preferred set of embodiments the weeds are selected from the group consisting of parkinsonia, prickly acacia, brigalow, mimosa pigra and combinations thereof.

In a preferred set of embodiments the weeds have a confined root system such as those selected from the group consisting of gorse, parthenium, sifton bush/Chinese scrub, holly bush, African box thorn, sweet briar, current bush, lime bush, blue heliotrope and combinations thereof.

The composition and method of the invention are particularly useful in control of one or more weeds selected from Brigalow, Parkinsonia, Prickly Acacia and Mimosa Pigra.

We have found that the method is particularly useful in control of weeds of relatively confined root systems such as gorse and parthenium. We have found that the spheronised particles of uniform size as herein described provide a very significant improvement in weed control, particularly of woody and herbaceous plants and sugar cane, when applied by aerial broadcasting. In particular, the granule composition of the invention provides greater control of granule distribution including more even control of weeds in the area to which the granules are applied and the granules result in fewer “hot spots” with comparatively high concentration of granules than the general area of distribution and fewer areas if inadequate control when compared with known extruded granules of less uniform aspect ratio. Of particular importance is the economy of active application and reduced costs. More economical application can be achieved by allowing aircraft to carry a greater load of active to increase the coverage per load.

The granules may be applied from the ground by hand or land based vehicle or an aircraft. The method of the invention is particularly advantageous when the granules are applied from an aircraft. In one set of embodiments the granules are applied using a helicopter. The uniform particle size provided by the process and the facility to include high active loading provide a significant advantage for broadcasting of granules by aircraft. This enables homogeneous application and reduced off-target scatter. Higher loading of small granules of tightly controlled monodisperse size distribution allows operators to treat a greater area of ground surface for each aircraft flight (since aerial application is limited by the volume of granules that can be placed in the hopper that is installed in the aircraft).

In one set of embodiments, the granules are broadcast from a drone (pilotless radio-controlled aircraft).

In one set of embodiments the granules are applied using a helicopter having an application speed of greater than 60 km/hr, preferably greater than 80 km/hr and a granule carrying capacity of greater than 50 kg, preferably greater than 100 kg, preferably greater than 200 kg. The area treated per hopper load is preferably greater than 10 ha, preferably greater than 20 ha, more preferably 25 ha, still more preferably 35 ha.

In one set of embodiments the granules are applied using a fixed wing aircraft having an application speed of greater than 100 km/hr, preferably greater than 150 km/hr, and a granule carrying capacity of greater than 400 kg, preferably greater than 800 kg, more preferably 1500 kg. The area treated per hopper load is preferably greater than 80 ha, more preferably greater than 100 ha, still more preferably greater than 150 ha.

The invention will now be described with reference to the following examples. It is to be understood that the examples are provided by way of illustration of the invention and that they are in no way limiting to the scope of the invention.

### EXAMPLES

### Examples 1-4

The following formulations designated Examples 1-4 (composition as in Table 2) were made into granules using the method of the invention as described in Example 5.

TABLE 2

| | | Example 2 | Example 3 | Example 4 |
|---|---|---|---|---|
| | Example 1 | Tebuthiuron | Hexazinone | Tebuthiiuron |
| | Tebuthiuron | 600 g/Kg | 400 g/Kg | 400 g/Kg |
| Component | 400 g/Kg | (parts by wt) | (part by wt) | (parts by wt) |
| Tebuthiuron | 416.6 | 625 | — | 416.6 |
| 96% | | | | |
| Hexazinone | — | — | 412.4 | — |
| 97% | | | | |
| kaolin | 316.1 | 107.1 | 316.1 | 316.1 |
| Plaster-of-Paris | 47.5 | 47.5 | 47.5 | 47.5 |
| Ball milled | 47.5 | 47.5 | 47.5 | 47.5 |
| accelerator | | | | |
| (gypsum-based) | | | | |
| Reax 85A | 89.3 | 89.3 | 89.3 | — |
| Lignosulfonate | | | | |
| pH | | | | |
| (15% solution) | | | | |
| 10.4 | | | | |
| Lignin DS 10 | — | — | — | 89.3 |
| Lignosulfonate | | | | |
| pH (10% soln) | | | | |
| 5-7 | | | | |
| Water added to | 140 | 140 | 140 | 140 |
| powder | | | | |
| Water added in | 10 | 10 | 10 | 10 |
| spheroniser | | | | |

*The particle size of the ball milled gypsum was 30 microns to 150 microns

The granules in Example 1 (directly after extrusion) had a crush strength of 20 g which built to 450 g.

A number of tests were undertaken on the final product as follows:
Appearance—the requirement is spherical granules;
pH (CIPAC MT75.3) (1%)—the requirement is 7.5-8.5;
pour and bulk density (CIPAC MT 186) (g/ml)—The requirement is 0.6-0.9;
Dust content (CIPAC MT171) (%)—The requirement is max 1% less than 50 micron;
Friability and attrition characteristics (CIPAC MT178.2) (%)—the requirement is min 98% retained on 125 micron sieve; and
Active ingredient concentration (g/kg)—the requirement is 575-625.

Formulations Examples 1-4 passed the above tests. The formulation of Example 1 yielded greater than 95% of granules of the required size.

### Example 5 (Process)

A 40 Kg batch of powder blend components (see Table 2, components do not include added water) are added to a high speed mixing vessel. The high speed mixing vessel (ZGH Vertical high speed mixer available (from Changzhou Yongchang Co) consisted of a cylindrical side wall of diameter 1 metre and a flat base and contained an impeller consisting of a vertical shaft and three evenly spaced blades adjacent the base with the blades extending to adjacent the side wall (about 45 cm long). The angular velocity of the impeller when in motion was 300 r.p.m which corresponds with a tip speed of about 20 m/s. The impeller blades were pitched to provide upward thrust of the powder. The above high speed mixer was fitted with a clamp-on lid having a port for addition of water and also a discharge chute at the bottom of the vessel which allows the contents to be discharged while the impeller is in motion. The discharge chute was located above a horizontal screw or auger so as to discharge the moist mixture onto the auger which conveys the mixture to the input of a rotating basket extruder.

In operation the High Speed Mixer is left OFF, until all ingredients are in the mixer vessel (excluding water). The lid is then fastened. The mixer is run for 10 seconds (The tip speed of the impeller is in the range 10 m/s to 30 m/s. and rotational velocity of the impeller is in the range of 300 r.p.m. to 600 r.p.m) to mix ingredients DRY and then 6 litres of water by weight are introduced over a period of 10 seconds through the port in the mixer lid while the impeller is going. Once water addition is complete, agitation is continued for a further 10 seconds for final mixing. After mixing for 10 seconds the mixture is no longer dusty and is discharged into a hopper which provided controlled loading on the auger below the hopper. The composition is in the form of a finely divided mixture which can be pressed by hand into a coherent mass.

It is important that over-mixing is avoided as this can result in inhomogeneity in the composition such as the formation of balls or clumps of moist mixture. The problem of over-mixing is associated with the inclusion of hydratable calcium sulfate in the composition.

Longer mixing times can also lead to increased temperature from the hydration reaction leading poor cohesion after extrusion. The completed mix is quite dry and should just form or stay together if squeezed by hand. The temp was 15° C. Inside manufacturing room there was a 35% relative humidity (Delta-T was 7° C.).

The moist material is fed onto the auger and into a basket extruder. The basket is a vertically disposed cylindrical shape having porous walls providing orifices of 3 mm diameter for extrusion. Relative rotation of blades within the basket urges the moist mixture through the pores in the basket extruder. Eight cutting blades are disposed on the outside of the rotating basket to chop the extrudate as it emerges from the pores.

The chopped extrudate (approx. 46 Kg) is placed into a rotating disc spheroniser and after closing the lid of the spheroniser the rotating disc is switched on (600 r.p.m.) for about 10 minutes.

During spheronisation a water spray (300 ml) is slowly fed into the interior of the spheroniser. After leaving the spheroniser the spheronised granules are then placed on a perforated inclined plane dryer (driven by bursts of ambient temperature air) and thereafter the granules are moved to a sieve where oversized granules are removed. They granules increase in hardness over 40 minutes.

### Example 6 (Further Composition Example)

Flupropanate

Flupropanate herbicide is provided as a concentrated aqueous liquid containing 745 g/L of active agent.

The formulation of Table 3 was made using the method of the invention. Note that the aqueous flupropanate concentrate was the aqueous liquor added to the powder blend.

TABLE 3

| | | | Concen- | |
|---|---|---|---|---|
| | | | tration | |
| Component | CAS # | Chemical name | (g/kg) | Function |
| Flupropanate | 22898-10-7 | Sodium | 166 | herbicide |
| aq conc | | tetrafluoropropionate | | |
| (745 g/L) | | | | |
| Kaolin clay | 1318-74-7 | kaolinite | 594 | filler |
| POP | 10034-76-1 | Plaster of Paris, | 47.5 | Setting |
| | | calcium sulfate | | agent |
| | | hemihydrate | | |
| Ball-milled | 10101-41-4 | Calcium sulfate | 47.5 | accelerant |
| gypsum | | dihydrate | | |
| accelerator | | | | |
| Reax 85A | 105859-97-0 | Lignin, alkali, | 89.3 | dispersant |
| | | sodium salt | | |
| Calcium | 1592-23-0 | Calcium stearate | 33 | lubricant |
| stearate | | | | |

The quantity of flupropanate in the above formulation may be increased by loading flupropanate liquor concentrate into finely divided porous materials (eg porous silica), and partially replacing kaolin filler with these loaded porous materials.

### Example 7. Further Example Using Liquid Aqueous Agrichemical

The active agent concentrate in this example was an aqueous (alkaline) seaweed extract (9% solids including approx. 5% alginate together with plant hormones and other material extracted by alkaline extraction liquor)—this extract is a growth promoter for plants and also acts to stimulate root growth.

The dry mix shown in Table 4 was made:

TABLE 4

| | | | Parts | |
|---|---|---|---|---|
| Component | CAS # | Chemical name | (weight) | Function |
| Kaolin clay | 1318-74-7 | kaolinite | 594 | filler |
| POP | 10034-76-1 | Plaster of Paris, | 47.5 | Setting |
| | | calcium sulfate | | agent |
| | | hemihydrate | | |
| Ball-milled | 10101-41-4 | Calcium sulfate | 47.5 | accelerant |
| gypsum | | dihydrate | | |
| accelerator | | | | |
| Reax 85A | 105859-97-0 | Lignin, alkali, | 89.3 | dispersant |
| | | sodium salt | | |
| Calcium | 1592-23-0 | Calcium stearate | 33 | lubricant |
| stearate | | | | |
| total | | | 811 | |

To 200 g of the above dry mix was added 50 g aqueous seaweed extract under rapid agitation, and granules were made using the method of the invention.

Granules were prepared in accordance with the general procedure of Example 5.

The quantity of seaweed extract in the above formulation may be increased by loading seaweed extract liquor into finely divided porous materials (eg porous silica), and partially replacing kaolin filler with these loaded porous materials.

### Example 7—Bioefficacy

The formulation of Example 1 (Tebuthiuron 400 g/L) was compared with another tebuthiuron granule (also 400 g/L, denoted TG 400) that had been previously found to be bioequivalent (per unit weight of tebuthiuron) to commercially available tebuthiuron granules (such as Regain 200, sold by Granular Products in Australia).

The granules of Example 1 were applied from a fixed-wing aircraft at 7.3 kg/ha of granules to a pasture site infested with Brigalow. The control treatment was 7.3 kg/ha of TG 400 granules.

14 Months after application of the granules, it was found that significant damage to Brigalow infestation occurred with both granule types, and that the level of damage was substantially equivalent.

1. A process of preparing agrichemical granules comprising:
addition of aqueous liquid to a rapidly mixing powder composition comprising a carrier including hydratable calcium sulfate, to form a pliable moist mixture with rapid mixing such that the mixing time to reach homogeneity of the composition following addition of water is within is within two minutes of addition of the aqueous liquid, wherein the aqueous liquid is added in an amount of at least 5 wt % water by weight of the moist mixture composition and at least one of the aqueous liquid and powder composition comprise an agrichemical active agent concentrate wherein the weight ratio of said active agent concentrate to hydratable calcium sulfate concentration is at least 1:1; and
shaping the pliable moist mixture by extrusion to form granules.

2. The process of claim 1 wherein the pliable moist mixture is shaped by extrusion to form an extrudate which is cut and/or rolled to form granules.

3. The process of claim 1 wherein the hydratable calcium sulfate is calcium sulfate hemihydrate.

4. The process of claim 1, wherein the ratio of active agent concentrate to hydratable calcium sulfate concentration is at least 5:1.

5. The process of claim 1, wherein water addition and rapidly mixing of the powder composition is carried out for no more than 10 minutes, of commencing water addition.

6. The process of claim 1, wherein the wherein rapid mixing of the powder is carried out in a high speed mixer having an impeller.

7. (canceled)

8. The process of claim 1, wherein the mixing time to reach homogeneity of the composition following addition of water is within one minute.

9. (canceled)

10. (canceled)

11. The process of claim 2 wherein the extrudate is formed into granules by cutting the extrudate and rolling the cut extrudate in a spheroniser.

12. (canceled)

13. (canceled)

14. The process of claim 1, wherein the ratio of dry weight of the granule components to hydratable calcium sulfate is at least 3:1.

15. (canceled)

16. The process of claim 1, wherein the agrichemical active agent concentrate comprises at least one selected from the group consisting of herbicides, insecticides, fungicides, molluscicides, plant growth regulators, nematicides, rodenticides and algicides, plant hormones, plant nutrients, trace elements, bioactive proteins, soil wetters, soil conditioning materials, humic substances and fulvic substances.

17. The process of claim 16, wherein the agrichemical active agent concentrate is a herbicide.

18. The process claim 1, wherein the agrichemical active agent concentrate is selected from the group consisting of: tebuthiuron, Bacillus thuringiensis, hexazinone and flupropanate.

19. The process of claim 1, wherein the agrichemical active agent concentrate is selected from the group consisting of: tebuthiuron, hexazinone and flupropanate which is present in an amount of from 20% to 85% by weight based on the dry weight of the granule components.

20. The process of claim 1, wherein the granular composition comprises a sulfonate Surfactant.

21. The process of claim 1, wherein the water is added in the mixture in an amount in the range of from 8% to 25% by weight, based on the active and filler weight of the components.

22. The process of claim 1, wherein the powder composition comprises an accelerating agent for hydration of the hydratable calcium sulfate selected from the group consisting of calcium sulfate dihydrate, fully hydrate zinc sulfate and fully hydrated aluminium sulfate and the weight ratio of accelerator to hydratable calcium sulfate is from 1:4 to 4:1.

23. The process of claim 1, wherein the powder composition comprises an accelerator which is a ball milled mixture of gypsum and a material selected from sugar, starch and surfactant.

24. The process of claim 1, wherein the difference between the dry bulb temperature and the wet bulb temperature (delta-T), is at least 1° C. and no more than 10° C.

25. (canceled)

26. The process of claim 1, wherein the granules have a maximum dimension of 1 mm to 4 mm.

27. (canceled)

28. (canceled)

29. The process of claim 28 wherein the weight of components based on the weight of pliable most mixture comprises:
8% to 20% water;
40% to 60% tebuthiuron or hexazinone;
3% to 6% calcium sulfate hemihydrate;
3% to 6% gypsum;
10% to 35% of a clay carrier; and
0% to 15% sulfate surfactant.

30. (canceled)

31. (canceled)
